(19) United States
(12) Patent Application Publication
(10) Pub. No.: US 2024/0154792 A1
(43) Pub. Date: May 9, 2024

(54) PRIVACY-PRESERVING FUZZY TOKENIZATION AND ACROSS DISPARATE DATASETS

(71) Applicant: TripleBlind, Inc., Kansas City, MO (US)

(72) Inventors: Riddhiman DAS, Parkville, MO (US); Craig GENTRY, New York, NY (US)

(21) Appl. No.: 18/505,003

(22) Filed: Nov. 8, 2023

Related U.S. Application Data
(60) Provisional application No. 63/382,778, filed on Nov. 8, 2022.

(51) Int. Cl. H04L 9/08; G06N 3/043; H04L 9/00; H04L 9/32

(52) U.S. Cl. CPC H04L 9/0833; G06N 3/043; H04L 9/008; H04L 9/3213

(57) ABSTRACT

A device may receive, at a privacy-preserving engine, first sensitive identifiers from a first dataset and second sensitive identifiers from a second dataset. A device may determine, via a fuzzy match algorithm, matches between the first sensitive identifiers and the second sensitive identifiers to yield a fuzzy match determination. A device may generate, via the fuzzy match algorithm, a set of unique identifiers in which each respective record of the first dataset and the second dataset is augmented by a respective unique identifier from the set of unique identifiers. A device may link records across the first dataset and the second dataset based on the respective unique identifier for each respective record.

### PRIORITY CLAIM

The present application claims priority to U.S. Provisional Application No. 63/382,778, filed on Nov. 8, 2022, the content of which is incorporated herein in its entirety.

### FIELD OF THE INVENTION

The following disclosure relates to privacy-preserving fuzzy tokenization and also to a process across disparate datasets.

### BACKGROUND

“Tokenization” is a process of substituting a sensitive data element—such as name, etc.—with a non-sensitive data string—called a token—that has no intrinsic or exploitable meaning or value. For example, when the token replaces a name, one can view the token as a kind of pseudonym. A token is typically generated using a pseudorandom one-way cryptographic process, so that the original sensitive element cannot be reverse engineered from the token. In this sense, tokenization provides a certain amount of privacy.

Tokenization maps two identical sensitive elements to identical strings. Therefore, tokenization allows “linking” or “matching”. For example, to find the intersection of two different datasets, the system can use tokenization: the owner of each dataset applies the same tokenization algorithm to their own dataset, and they discover the intersection from the matching tokens.

Although tokenization allows a kind of privacy called pseudonymity, in fact this level of privacy is not very high, since “linking” and “matching” tokens implicitly links or matches underlying sensitive data elements. There are many papers in the cybersecurity literature that show that the mere ability to link data across datasets via tokens can be used to recover the sensitive data elements themselves (e.g., actual names of the underlying people) via so-called re-identification (re-ID) attacks, especially when the attacker cross-references these linkages with publicly available auxiliary information, such as the information available via social media.

The simplest approach to tokenization is to simply apply a cryptographic function (such as a hash function) directly to a sensitive element such as a name. If two datasets use the same cryptographic function, and also use the same names for the same people, the matching tokens will correspond to matching people. One problem with this approach is that often datasets have slightly different variants of the same person's name. The tokens for these slightly differing names will be very different. It would be preferable to get matching tokens even if the names are slightly different, as long as they correspond to the same entity.

Disclosed next are three techniques for getting matching tokens in this setting: fuzzy match, generalization then exact match, and re-ID.

The first approach to matching over slightly mismatched data is a two-phase approach. First, within each dataset, try to “generalize” the data. For example, if the sensitive data element consists of names, augment the dataset by (for each name) trying to write out every plausible variant of that name. Then, perform exact matching (perhaps after applying conventional tokenization). This approach is often better than conventional tokenization (without the generalization phase). However, it may have both false positives (from over-generalization) and false negatives (failure to generate all plausible variants of the element).

The second approach to matching tokens over slightly mismatched data is “fuzzy matching”. A distance metric can be used between two data strings, such as Jaro-Winkler, to measure whether the two strings have small edit distance—that is, whether a small number of editing changes to one string would give the other string. While fuzzy matching may recover more matches than exact matching, there are several disadvantages. First, an overly-liberal fuzzy matching algorithm may recover too many matches—that is, if the distance metric is too permissive or ill-suited to the data, fuzzy matching may return many false positives. Second, fuzzy matching compromises privacy. Whereas tokenization at least provides pseudonymity, fuzzy matching does not provide even that level of privacy—the strings in question must be seen completely for their mutual distance to be measured. Third, fuzzy matching is more expensive computationally than exact matching. Given n strings (e.g., tokens), one can use a computer to find exact duplicate strings using an algorithm that takes quasi-linear time (e.g., time O(n log n)). In contrast, given n strings, to find all pairs that fuzzily match, one must apply the fuzzy match measurement to each pair, which has computational complexity O(n\hat{ }2), as there are (n choose 2)=n(n+1)/2 pairs.

The third approach to matching tokens over slightly mismatched data is to perform a re-ID attack. That is, the data owners of each dataset, or some third-party facilitator, take their dataset and cross-reference it with other available data (such as data from social media) in an attempt to generate “true” and unique identifiers for the data. Each data owner is basically augmenting its data with other relevant data to learn the “ground truth”—e.g., a person's full name, as opposed to the partial name it has in its database. The more closely each data owner can learn the ground truth, the easier it will be for the data owners thereafter to match their data effectively—by using conventional tokenization or by performing fuzzy matching with a less permissive metric.

Each of the above approaches to matching over mismatched data has severe disadvantages. Notably, both fuzzy matching and the re-ID attack approach severely compromise privacy. This disclosure describes how to extract the utility out of the above approaches while minimizing compromises on privacy.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Embodiments can be developed based on the following disclosure. For example, method embodiments associated with the operation of the process can be focused on processes performed by servers, clients, cloud-based systems, mobile devices or a combination of any of these computing devices. Methods can also be covered from the standpoint of a router, an access point, a server, a client device, a cloud-based system, a mobile device, or any other computing device utilized by the protocol.

Privacy-enhanced computation (PEC), including such technologies as secure multi-party computation (SMPC) and homomorphic encryption (HE), allow data to be processed or computed on while it is secret-shared (in the sense of Shamir's secret sharing or other secret-sharing mechanisms) or while it is encrypted. PEC allows parties to do computations on their data without revealing that data to each other—in fact, without revealing any function of the data except precisely the function of the data that they wish to disclose. This disclosure describes how to use PEC to retain the utility of tokenization while enhancing its privacy. In fact, the described privacy-preserving tokenization system also enhances utility over the conventionally used generalize-then-match approach to tokenization, because it captures many matches that otherwise would be missed.

The concepts disclosed herein involve a system generating higher-quality identifiers than tokenization with generalization, a technique that is inherently limited by handling each dataset separately rather than pooling the dataset to better discover intersections. Indeed, this disclosure subsumes the latter technique (which can be performed inside a privacy-preserving computation) but extends it by privacy-preserving data pooling that can discover matches among mismatched sensitive identifiers that are not discovered by generalization. The system extracts the utility of the fuzzy match and re-ID techniques, but without the significant compromise in privacy that those techniques entail.

In one embodiment of the disclosure, the underlying sensitive identifiers of the datasets—e.g., names, addresses, etc.—are taken as inputs to a privacy-preserving computation. Matches between the sensitive identifiers are found by performing a privacy-preserving fuzzy match algorithm, where fuzzy match determination may be computed using an edit distance metric, such as Jaro-Winkler. Inside the privacy-preserving computation, pseudorandom strings are generated as unique identifiers, and each record in each dataset is augmented with one of the unique identifiers, with the constraint that records with sensitive identifiers that fuzzily match are given the same unique identifier. In subsequent computations involving the datasets, the unique pseudorandom identifiers can be used to quickly link records across the datasets.

In another embodiment of the disclosure, a privacy-preserving computation is applied to one or more datasets, possibly in combination with auxiliary information, which may include a master person index (MPI) or another collection of identifiers, and other data such as consumer or social media data that provides associations between that could allow re-identification of the records in the first dataset. Inside a privacy-preserving computation, re-identification is performed so as to associate the records in the first dataset(s) with sensitive identifiers (e.g., names) and to construct a mapping between sensitive identifiers and pseudorandom unique identifiers. The first dataset(s) is augmented with pseudorandom identifiers, and the mapping between the sensitive identifiers and pseudorandom identifiers is withheld and stored in a different location. Later, when parties would like to privately perform a joint computation on two or more datasets that have been augmented with these pseudorandom identifiers, the common identifiers simplify the computation by indicating the intersection of the datasets.

One could use non-privacy-preserving computation to perform fuzzy match or to perform re-ID and generate the unique identifiers, but the preferred embodiments of this disclosure are designed to protect privacy to the extent possible.

In some aspects, the techniques described herein relate to a method of privatizing private data, the method including: receiving, at a privacy-preserving engine, first sensitive identifiers from a first dataset and second sensitive identifiers from a second dataset; determining, via a fuzzy match algorithm, matches between the first sensitive identifiers and the second sensitive identifiers to yield a fuzzy match determination; generating, via the fuzzy match algorithm, a set of unique identifiers in which each respective record of the first dataset and the second dataset is augmented by a respective unique identifier from the set of unique identifiers; and linking records across the first dataset and the second dataset based on the respective unique identifier for each respective record.

In some aspects, the techniques described herein relate to a system for privatizing private data, the system including: one or more processors; and a computer-readable storage device storing instructions which, when executed by the one or more processors, cause the one or more processors to perform operations including: receiving, at a privacy-preserving engine, first sensitive identifiers from a first dataset and second sensitive identifiers from a second dataset; determining, via a fuzzy match algorithm, matches between the first sensitive identifiers and the second sensitive identifiers to yield a fuzzy match determination; generating, via the fuzzy match algorithm, a set of unique identifiers in which each respective record of the first dataset and the second dataset is augmented by a respective unique identifier from the set of unique identifiers; and linking records across the first dataset and the second dataset based on the respective unique identifier for each respective record.

In some aspects, the techniques described herein relate to a method of privatizing private data, the method including: receiving, at a privacy-preserving engine, first sensitive identifiers from a first dataset of a set of primary datasets; determining, via a fuzzy match algorithm, matches between the first sensitive identifiers and a second sensitive identifiers associated with auxiliary information to yield a fuzzy match determination; generating, via the fuzzy match algorithm, a set of unique identifiers in which each respective record of the first dataset is augmented by a respective unique identifier from the set of unique identifiers; and linking records across the first dataset and the auxiliary information based on the respective unique identifier for each respective record.

In some aspects, the techniques described herein relate to a system for privatizing private data, the system including: one or more processors; and a computer-readable storage device storing instructions which, when executed by the one or more processors, cause the one or more processors to perform operations including: receiving, at a privacy-preserving engine, first sensitive identifiers from a first dataset of a set of primary datasets; determining, via a fuzzy match algorithm, matches between the first sensitive identifiers and a second sensitive identifiers associated with auxiliary information to yield a fuzzy match determination; generating, via the fuzzy match algorithm, a set of unique identifiers in which each respective record of the first dataset is augmented by a respective unique identifier from the set of unique identifiers; and linking records across the first dataset and the auxiliary information based on the respective unique identifier for each respective record.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

Illustrative aspects of the present application are described in detail below with reference to the following figures:

FIG. 1 illustrates a system in which different data sets are held by different computing systems in accordance with some aspects of this disclosure;

FIG. 2A illustrates a method aspect in accordance with some aspects of this disclosure;

FIG. 2B illustrates a method aspect in accordance with some aspects of this disclosure; and

FIG. 3 illustrates a computing device in according with some aspects of this disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

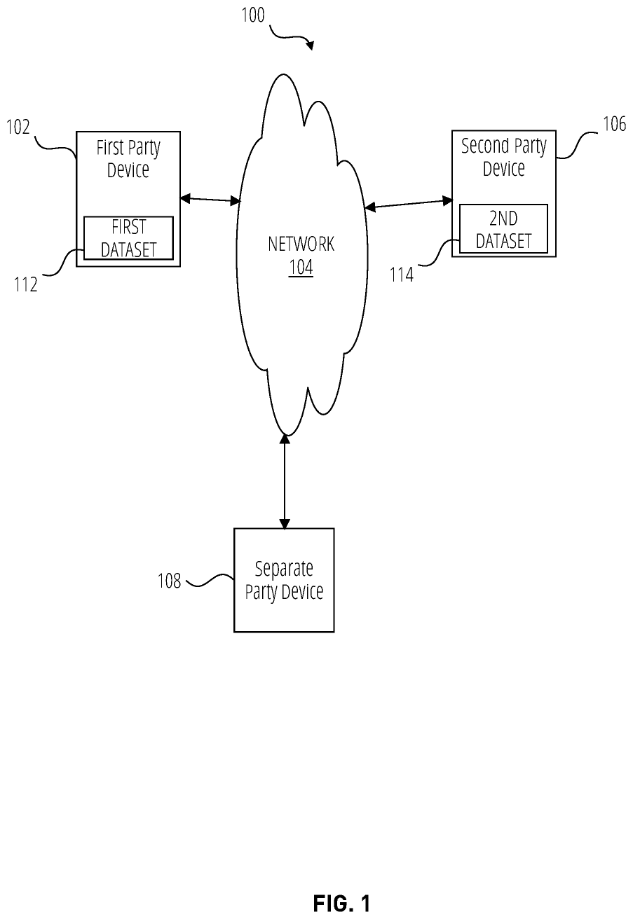

This disclosure envisions one or more primary datasets stored on one or more party devices. FIG. 1 illustrates a system 100 having a first party device 102 having a first dataset 112, a network 104, a second party device 106 having a second dataset 114 and a separate party device 108. These primary datasets may have sensitive identifiers, or they may be de-identified so that the sensitive identifiers are not included. The primary datasets (e.g., the first dataset 112 and the second dataset 114) are stored in computer systems such as the first party device 102 and/or the second party device 106. Typically, disparate datasets will be stored in disparate computer systems, and may have disparate access control policies. The computer systems that store the primary datasets are connected to a network 104, such as the Internet or other network.

In the preferred embodiment of the disclosure, there are two or more primary datasets, each of which have sensitive identifiers. The sensitive identifiers could be name, address, and/or other identifiers such as the 18 HIPAA (Health Insurance Portability and Accountability Act) identifiers. In some aspects, the disclosed system can use privacy-preserving computation to augment the respective datasets (e.g., the first dataset 112 and the second dataset 114) with a set of unique identifiers that are pseudorandom, such that if records in the respective datasets fuzzily match on their sensitive identifiers they will exactly match on their pseudorandom identifiers.

In some aspects, the privacy-preserving computation involving the disparate datasets is facilitated and intermediated by a separate party via a separate party device 108, communicating over the Internet or the network 104, which brokers an agreement among the parties to perform the computation. The use of the separate party device 108 helps specify the computational steps to be taken by the parties and performs various other setup functions. Alternatively, the owners of the datasets (e.g., the first party device 102 and the second party device 106) can distributively perform these steps themselves. For example, first party device 102 and second party device 106 may collectively determine which steps are to be taken by which of first party device 102 and second party device 106 and may then execute the steps.

Any computation that can be performed on a computer or network of computers, whatever the hardware or software, can also be performed in a privacy-preserving way using techniques such as secure multi-party computation (SMPC) or homomorphic encryption (HE). The computation to be performed in the preferred embodiment is fuzzy matching for pairs of records according to their sensitive identifiers. Fuzzy matching may be defined with respect to any suitable distance metric, such as Jaro-Winkler. The Jaro-Winkler similarity is a string metric measuring an edit distance between two sequences. The Jaro-Winkler distance can use a prefix scale P which gives more favorable ratings to strings that match from the beginning for a set prefix length L. The higher the Jaro-Winkler distance for two strings is, the less similar the strings are. The score is normalized such that 0 means an exact match and 1 means there is no similarity. The metric in some aspects can be defined in terms of similarity, so the distance is defined as the inversion of that value (distance=1−similarity). Other metrics may be used and the Jaro-Winkler similarity is provided as one example.

Alternatively, the fuzzy-matching algorithm may be a step-wise algorithm—match on email, if no match, try fuzzy matching on name, if no match, try fuzzy matching on address, etc. In the extreme, fuzzy matching can be determined by a more complicated algorithm such a neural network or other machine learning algorithm. This disclosure supports a wide variety of fuzzy-matching techniques.

In some aspects, after the set of pairwise fuzzy matches is found, it is checked whether the fuzzy matching is transitive—that is, whether it is true for all records A, B, and C that if (A,B) and (B,C) each fuzzily match, then so does (A,C). If not, while such non-transitive fuzzy matching exists, the fuzziness of the matching is reduced (in the direction of exact matching) until the non-transitivity is eliminated (in the example by eliminating either (A,B) or (B,C) as a fuzzy match). This reduction of fuzziness can be local—affecting only the fuzziness threshold of a few records being compared—e.g., A, B, and C—rather than global (affecting all comparisons). Ultimately, the fuzzy matching becomes transitive, the extreme case being that the fuzziness is reduced all the way to exact matching, which is always transitive.)

Still working inside the privacy-preserving computation, the parties distributively generate a random identifier for each (transitive) equivalence class of records that fuzzily matches. The datasets are augmented and stored with these random identifiers, the appropriate random identifier to the appropriate record.

The expense of generating these random identifiers can be amortized over many subsequent computations. For example, later the parties might want to perform a privacy-preserving linear regression over their various datasets, where their datasets are joined using the common random identifiers. In such a process, each record corresponds to a single person that may have features recorded in each of the various datasets. Since the parties have already computed identifiers that allow the datasets to be consistently linked and joined, they can forgo doing this part of the computation again and proceed to the linear regression part of the computation.

In some aspects, there may be many primary datasets, but the privacy-preserving computation may operate on one primary dataset at a time, in combination with auxiliary information sufficient to perform re-ID, possibly including a master person index (MPI) and other data sources such as consumer data or social media data. The MPI and other auxiliary data, along with the re-ID procedure, may be held by some entity other than the primary dataset owner, which can be called the tokenization entity. The tokenization entity may be distributed cryptographically (using e.g., SMPC) across several entities for security reasons. In some aspects, the objective (within a privacy-preserving computation involving the primary dataset owner and the tokenization entity) is to match the records against the MPI (or other canonical identifier), with the help of the auxiliary information—i.e., to re-ID the primary dataset.

Examples of re-ID attacks are known by those skilled in the art. (For a survey, see El Emam et al., “A Systematic Review of Re-Identification Attacks on Health Data”, PLOS ONE, 2011.) For example, in its effort to encourage the development of a better recommendation engine, Netflix® released the de-identified movie ratings of 500,000 of its subscribers; attackers were able to re-ID the list by cross-referencing it with movie ratings on the Internet Movie Database (IMDb) website. Re-ID attacks are devastating for privacy. However, re-ID attacks can also be used for good—they can be performed under privacy-preserving computation for a limited purpose, in this case the purpose of generating unique random identifiers to augment disparate datasets, where these random identifiers can be used to speed up subsequent privacy-preserving computations across those datasets. Privacy can safely be temporarily reduced inside a privacy-preserving computation as long as the output of the computation respects privacy. In this case, the output consists merely of pseudorandom identifiers that are used to streamline future (preferably privacy-preserving) computations.

Once the re-ID procedure (within the privacy-preserving computation) associates canonical identifiers (like those in the MPI) with records, the computation then generates pseudorandom identifiers as pseudonyms for the canonical identifiers and reveals the pseudonymous random identifiers to the dataset owner along with their association to the records. Each primary dataset owner sees only those pseudorandom identifiers that correspond to its data, and the tokenization entity does not see any of the pseudorandom identifiers used. These pseudorandom identifiers may be generated using a pseudorandom function (PRF) whose key is held by the (possibly distributed) tokenization entity. The generation of the pseudorandom identifiers from the canonical identifiers is deterministic, thus ensuring that the same pseudorandom identifier is generated for each canonical identifier as the tokenization entity collaborates on privacy-preserving computations with multiple primary dataset owners.

In later computations, dataset owners can use the pseudorandom identifiers to intersect or join their datasets more efficiently while performing a privacy-preserving computation on their combined datasets.

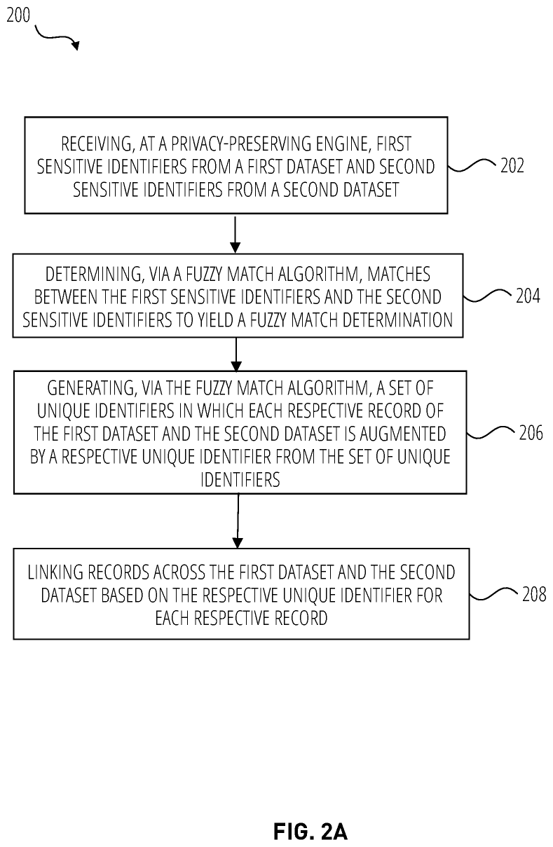

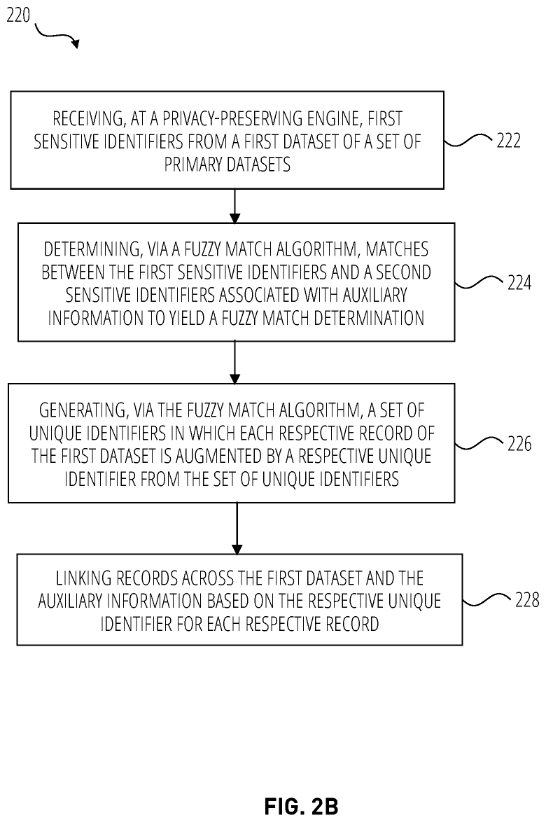

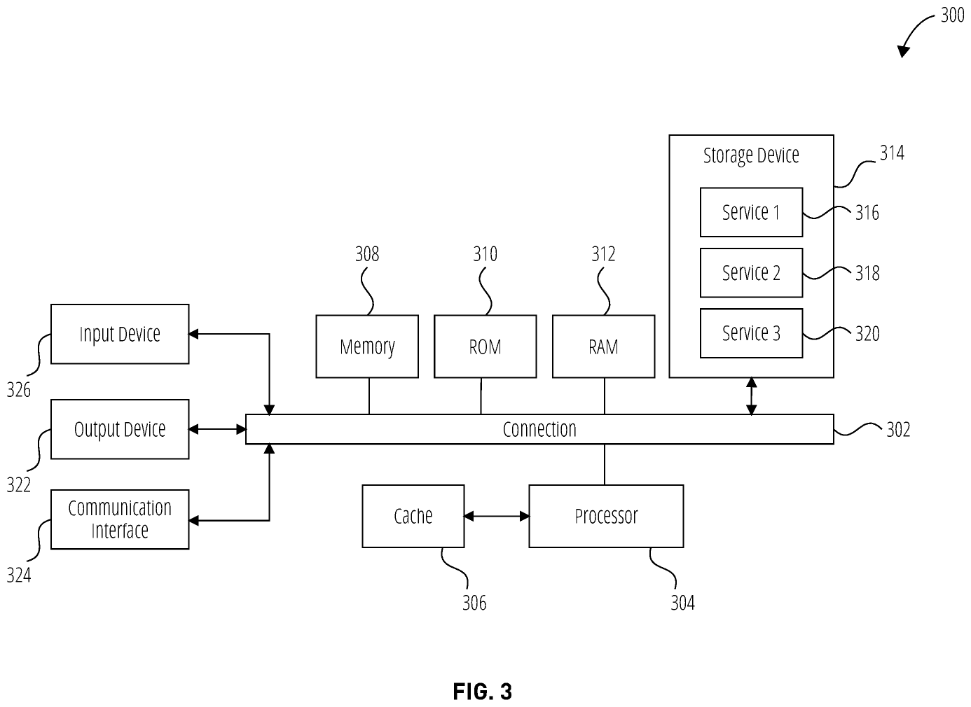

FIG. 2A illustrates a process 200 for performing privacy-preserving fuzzy tokenization across disparate datasets. The process 200 can be performed in the context of a system 100 that can include one or more computing devices that communicate over a network. The system 100 or components of the system 100 can be computing devices or computing systems 300 as shown in FIG. 3. The process 200 or method of privatizing data can include one or more of receiving, at a privacy-preserving engine, first sensitive identifiers from a first dataset and second sensitive identifiers from a second dataset (202). In some aspects, the first sensitive identifiers from the first dataset and the second sensitive identifiers from the second dataset can include one or more of a name, an address, a phone number, a physical characteristic of a person, an email address, a social-media handle, an age. In some aspects, the privacy-preserving engine can operate using one of secure multi-party computation or homomorphic encryption.

The process 200 can further include determining, via a fuzzy-match algorithm, matches between the first sensitive identifiers and the second sensitive identifiers to yield a fuzzy-match determination (204). The fuzzy-match determination can be computed using an edit distance metric. In some aspects, the edit distance metric can include a Jaro-Winkler similarity string metric. In some aspects, the fuzzy-match algorithm can perform generally according to a distance metric comprising one or more of a Jaro-Winkler metric, a step-wise algorithm, a neural network, a machine learning algorithm or other distance metric algorithm. The fuzzy match algorithm can perform fuzzy matching for pairs or records according to the first sensitive identifiers and the second sensitive identifiers.

The process 200 can include generating, via the fuzzy-match algorithm, a set of unique identifiers in which each respective record of the first dataset and the second dataset is augmented by a respective unique identifier from the set of unique identifiers (206). The records of the first dataset and the second dataset with sensitive identifiers that fuzzily match in the fuzzy match determination can be augmented with a same unique identifier. In some cases, the set of unique identifiers comprises a set of pseudorandom strings and the respective unique identifier comprises a respective pseudorandom string of the set of pseudorandom strings.

The process 200 can further include linking records across the first dataset and the second dataset based on the respective unique identifier for each respective record (208).

In some aspects, the first dataset can be associated with a first device (e.g., first party device 102), the second dataset can be associated with a second device (e.g., the second party device 106), and the privacy-preserving engine can operate on a third-party independent computing device (e.g., the separate party device 108). The privacy-preserving engine further can broker an agreement between the first device and the second device to perform computations when it operates on the separate party device 108.

In some aspects, after determining, via the fuzzy match algorithm, matches between the first sensitive identifiers and the second sensitive identifiers to yield the fuzzy match determination, the method can further include determining whether the fuzzy match determination is transitive. While the fuzzy match determination is not transitive, the method can include reducing a fuzziness of a matching operation until a non-transitivity state is eliminated.

In another aspect, the method can include distributively generating a respective random identifier, as part of the set of unique identifiers, for each transitive equivalence class of records of the fuzzy match determination.

A system (e.g., a computing system 300, a separate party device 108, or a combination of other devices like the first party device 102 and the second party device 106) for privatizing private data can include one or more processors and a computer-readable storage device storing instructions which, when executed by the one or more processors, cause the one or more processors to perform operations including one or more of: receiving, at a privacy-preserving engine, first sensitive identifiers from a first dataset and second sensitive identifiers from a second dataset; determining, via a fuzzy match algorithm, matches between the first sensitive identifiers and the second sensitive identifiers to yield a fuzzy match determination; generating, via the fuzzy match algorithm, a set of unique identifiers in which each respective record of the first dataset and the second dataset is augmented by a respective unique identifier from the set of unique identifiers; and linking records across the first dataset and the second dataset based on the respective unique identifier for each respective record.

FIG. 2B illustrates a method 220 of privatizing private data. The method 220 can include one or more steps including receiving, at a privacy-preserving engine, first sensitive identifiers from a first dataset of a set of primary datasets (222), determining, via a fuzzy match algorithm, matches between the first sensitive identifiers and a second sensitive identifiers associated with auxiliary information to yield a fuzzy match determination (224), generating, via the fuzzy match algorithm, a set of unique identifiers in which each respective record of the first dataset is augmented by a respective unique identifier from the set of unique identifiers (226), and linking records across the first dataset and the auxiliary information based on the respective unique identifier for each respective record (228).

The fuzzy match algorithm can operate one at a time on respective datasets from the set of primary datasets using the auxiliary information. The auxiliary information can include a master person index and other data comprising one or more of consumer data and social media data.

The auxiliary information may be held by a tokenization entity which can be represented by the separate party device 108. The tokenization entity in some aspects may not be a single computer or computer cluster but may be distributed cryptographically across several distributed computing devices. In some aspects, the tokenization entity can be a blockchain network with distributed nodes in which a consensus algorithm is distributed across the nodes to determine whether to record transactions across a distributed ledger.

The tokenization entity can be distributed cryptographically across several distributed computing devices via use of secure multi-party computation.

A system for privatizing private data can include one or more processors and a computer-readable storage device storing instructions which, when executed by the one or more processors, cause the one or more processors to perform operations including one or more of: receiving, at a privacy-preserving engine, first sensitive identifiers from a first dataset of a set of primary datasets; determining, via a fuzzy match algorithm, matches between the first sensitive identifiers and a second sensitive identifiers associated with auxiliary information to yield a fuzzy match determination; generating, via the fuzzy match algorithm, a set of unique identifiers in which each respective record of the first dataset is augmented by a respective unique identifier from the set of unique identifiers; and linking records across the first dataset and the auxiliary information based on the respective unique identifier for each respective record.

FIG. 3 shows an example of computing system 300, which can be for example any computing device used to compare two number, or any component thereof including components of the system that are in communication with each other using connection 302. Connection 302 can be a physical connection via a bus, or a direct connection into processor 304, such as in a chipset architecture. Connection 302 can also be a virtual connection, networked connection, or logical connection.

In some aspects, computing system 300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 300 includes at least one processing unit (CPU or processor) 304 and connection 302 that couples various system components including system memory 308, such as read-only memory (ROM) 310 and random-access memory (RAM) 312 to processor 304. Computing system 300 can include a cache of high-speed memory 306 connected directly with, in close proximity to, or integrated as part of processor 304.

Processor 304 can include any general-purpose processor and a hardware service or software service, such as services 316, 318, and 320 stored in storage device 314, configured to control processor 304 as well as a special-purpose processor where software instructions are incorporated into the actual processor design. Processor 304 may essentially be a completely self-contained computing system, containing multiple cores or processors, a bus, memory controller, cache, etc. A multi-core processor may be symmetric or asymmetric.

To enable user interaction, computing system 300 includes an input device 326, which can represent any number of input mechanisms, such as a microphone for speech, a touch-sensitive screen for gesture or graphical input, keyboard, mouse, motion input, speech, etc. Computing system 300 can also include output device 322, which can be one or more of a number of output mechanisms known to those of skill in the art. In some instances, multimodal systems can enable a user to provide multiple types of input/output to communicate with computing system 100. Computing system 300 can include communication interface 324, which can generally govern and manage the user input and system output. There is no restriction on operating on any particular hardware arrangement, and therefore the basic features here may easily be substituted for improved hardware or firmware arrangements as they are developed.

Storage device 314 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 314 can include software services, servers, services, etc., that when the code that defines such software is executed by the processor 304, it causes the system to perform a function. In some embodiments, a hardware service that performs a particular function can include the software component stored in a computer-readable medium in connection with the necessary hardware components, such as processor 304, connection 302, output device 322, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Clauses of this application include:

Clause 1. A method of privatizing private data, the method comprising: receiving, at a privacy-preserving engine, first sensitive identifiers from a first dataset and second sensitive identifiers from a second dataset; determining, via a fuzzy match algorithm, matches between the first sensitive identifiers and the second sensitive identifiers to yield a fuzzy match determination; generating, via the fuzzy match algorithm, a set of unique identifiers in which each respective record of the first dataset and the second dataset is augmented by a respective unique identifier from the set of unique identifiers; and linking records across the first dataset and the second dataset based on the respective unique identifier for each respective record.

Clause 2. The method of clause 1, wherein the first sensitive identifiers from the first dataset and the second sensitive identifiers from the second dataset comprise one or more of a name, an address, a phone number, a physical characteristic of a person, an email address, a social media handle, an age.

Clause 3. The method of clause 1 or any previous clause, wherein the fuzzy match determination is computed using an edit distance metric.

Clause 4. The method of clause 3 or any previous clause, wherein the edit distance metric comprises a Jaro-Winkler similarity string metric.

Clause 5. The method of clause 1 or any previous clause, wherein records first dataset and the second dataset with sensitive identifiers that fuzzily match in the fuzzy match determination are augmented with a same unique identifier.

Clause 6. The method of clause 1 or any previous clause, wherein the set of unique identifiers comprises a set of pseudorandom strings.

Clause 7. The method of clause 6 or any previous clause, wherein the respective unique identifier comprises a respective pseudorandom string of the set of pseudorandom strings.

Clause 8. The method of clause 1 or any previous clause, wherein the first dataset is associated with a first device, the second dataset is associated with a second device, and the privacy-preserving engine operates on a third-party independent computing device.

Clause 9. The method of clause 8 or any previous clause, wherein the privacy-preserving engine further brokers an agreement between the first device and the second device to perform computations.

Clause 10. The method of clause 1 or any previous clause, wherein the privacy-preserving engine operates using one of secure multi-party computation or homomorphic encryption.

Clause 11. The method of clause 1 or any previous clause, wherein the fuzzy match algorithm performs according to a distance metric comprising one or more of a Jaro-Winkler metric, a step-wise algorithm, a neural network, a machine learning algorithm or other distance metric algorithm.

Clause 12. The method of clause 1 or any previous clause, wherein the fuzzy match algorithm performs fuzzy matching for pairs or records according to the first sensitive identifiers and the second sensitive identifiers.

Clause 13. The method of clause 1 or any previous clause, wherein after determining, via the fuzzy match algorithm, matches between the first sensitive identifiers and the second sensitive identifiers to yield the fuzzy match determination, the method comprises: determining whether the fuzzy match determination is transitive.

Clause 14. The method of clause 13 or any previous clause, wherein, while the fuzzy match determination is not transitive, reducing a fuzziness of a matching operation until a non-transitivity state is eliminated.

Clause 15. The method of clause 1 or any previous clause, further comprising: distributively generating a respective random identifier, as part of the set of unique identifiers, for each transitive equivalence class of records of the fuzzy match determination.

Clause 16. A system for privatizing private data, the system comprising: one or more processors; and a computer-readable storage device storing instructions which, when executed by the one or more processors, cause the one or more processors to perform operations comprising: receiving, at a privacy-preserving engine, first sensitive identifiers from a first dataset and second sensitive identifiers from a second dataset; determining, via a fuzzy match algorithm, matches between the first sensitive identifiers and the second sensitive identifiers to yield a fuzzy match determination; generating, via the fuzzy match algorithm, a set of unique identifiers in which each respective record of the first dataset and the second dataset is augmented by a respective unique identifier from the set of unique identifiers; and linking records across the first dataset and the second dataset based on the respective unique identifier for each respective record.

Clause 17. A method of privatizing private data, the method comprising: receiving, at a privacy-preserving engine, first sensitive identifiers from a first dataset of a set of primary datasets; determining, via a fuzzy match algorithm, matches between the first sensitive identifiers and a second sensitive identifiers associated with auxiliary information to yield a fuzzy match determination; generating, via the fuzzy match algorithm, a set of unique identifiers in which each respective record of the first dataset is augmented by a respective unique identifier from the set of unique identifiers; and linking records across the first dataset and the auxiliary information based on the respective unique identifier for each respective record.

Clause 18. The method of clause 17, wherein the fuzzy match algorithm operates one at a time on respective datasets from the set of primary datasets using the auxiliary information.

Clause 19. The method of any of clauses 17-18, wherein the auxiliary information comprises a master person index and other data comprising one or more of consumer data and social media data.

Clause 20. The method of any of clauses 17-19, wherein the auxiliary information is held by a tokenization entity.

Clause 21. The method of any of clauses 17-20, wherein the tokenization entity is distributed cryptographically across several distributed computing devices.

Clause 22. The method of any of clauses 17-21, wherein the tokenization entity is distributed cryptographically across several distributed computing devices via use of secure multi-party computation.

Clause 23. A system for privatizing private data, the system comprising: one or more processors; and a computer-readable storage device storing instructions which, when executed by the one or more processors, cause the one or more processors to perform operations comprising: receiving, at a privacy-preserving engine, first sensitive identifiers from a first dataset of a set of primary datasets; determining, via a fuzzy match algorithm, matches between the first sensitive identifiers and a second sensitive identifiers associated with auxiliary information to yield a fuzzy match determination; generating, via the fuzzy match algorithm, a set of unique identifiers in which each respective record of the first dataset is augmented by a respective unique identifier from the set of unique identifiers; and linking records across the first dataset and the auxiliary information based on the respective unique identifier for each respective record.

Clause 24. A system including means for performing any of the methods or operations of any of clauses 1-23.

Clause 25. A computer-readable storage medium storing instructions for causing one or more processors to perform any of the methods or operations of any of clauses 1-23.

What is claimed is:

1. A method of privatizing private data, the method comprising:
receiving, at a privacy-preserving engine, first sensitive identifiers from a first dataset and second sensitive identifiers from a second dataset;
determining, via a fuzzy match algorithm, matches between the first sensitive identifiers and the second sensitive identifiers to yield a fuzzy match determination;
generating, via the fuzzy match algorithm, a set of unique identifiers in which each respective record of the first dataset and the second dataset is augmented by a respective unique identifier from the set of unique identifiers; and
linking records across the first dataset and the second dataset based on the respective unique identifier for each respective record.

2. The method of claim 1, wherein the first sensitive identifiers from the first dataset and the second sensitive identifiers from the second dataset comprise one or more of a name, an address, a phone number, a physical characteristic of a person, an email address, a social media handle, an age.

3. The method of claim 1, wherein the fuzzy match determination is computed using an edit distance metric.

4. The method of claim 3, wherein the edit distance metric comprises a Jaro-Winkler similarity string metric.

5. The method of claim 1, wherein records first dataset and the second dataset with sensitive identifiers that fuzzily match in the fuzzy match determination are augmented with a same unique identifier.

6. The method of claim 1, wherein the set of unique identifiers comprises a set of pseudorandom strings.

7. The method of claim 6, wherein the respective unique identifier comprises a respective pseudorandom string of the set of pseudorandom strings.

8. The method of claim 1, wherein the first dataset is associated with a first device, the second dataset is associated with a second device, and the privacy-preserving engine operates on a third-party independent computing device.

9. The method of claim 8, wherein the privacy-preserving engine further brokers an agreement between the first device and the second device to perform computations.

10. The method of claim 1, wherein the privacy-preserving engine operates using one of secure multi-party computation or homomorphic encryption.

11. The method of claim 1, wherein the fuzzy match algorithm performs according to a distance metric comprising one or more of a Jaro-Winkler metric, a step-wise algorithm, a neural network, a machine learning algorithm or other distance metric algorithm.

12. The method of claim 1, wherein the fuzzy match algorithm performs fuzzy matching for pairs or records according to the first sensitive identifiers and the second sensitive identifiers.

13. The method of claim 1, wherein after determining, via the fuzzy match algorithm, matches between the first sensitive identifiers and the second sensitive identifiers to yield the fuzzy match determination, the method comprises:
determining whether the fuzzy match determination is transitive.

14. The method of claim 13, wherein, while the fuzzy match determination is not transitive, reducing a fuzziness of a matching operation until a non-transitivity state is eliminated.

15. The method of claim 1, further comprising:
distributively generating a respective random identifier, as part of the set of unique identifiers, for each transitive equivalence class of records of the fuzzy match determination.

16. A system for privatizing private data, the system comprising:
one or more processors; and
a computer-readable storage device storing instructions which, when executed by the one or more processors, cause the one or more processors to perform operations comprising:
receiving, at a privacy-preserving engine, first sensitive identifiers from a first dataset and second sensitive identifiers from a second dataset;
determining, via a fuzzy match algorithm, matches between the first sensitive identifiers and the second sensitive identifiers to yield a fuzzy match determination;
generating, via the fuzzy match algorithm, a set of unique identifiers in which each respective record of the first dataset and the second dataset is augmented by a respective unique identifier from the set of unique identifiers; and
linking records across the first dataset and the second dataset based on the respective unique identifier for each respective record.

17. A method of privatizing private data, the method comprising:
receiving, at a privacy-preserving engine, first sensitive identifiers from a first dataset of a set of primary datasets;
determining, via a fuzzy match algorithm, matches between the first sensitive identifiers and a second sensitive identifiers associated with auxiliary information to yield a fuzzy match determination;
generating, via the fuzzy match algorithm, a set of unique identifiers in which each respective record of the first dataset is augmented by a respective unique identifier from the set of unique identifiers; and
linking records across the first dataset and the auxiliary information based on the respective unique identifier for each respective record.

18. The method of claim 17, wherein the fuzzy match algorithm operates one at a time on respective datasets from the set of primary datasets using the auxiliary information.

19. The method of claim 17, wherein the auxiliary information comprises a master person index and other data comprising one or more of consumer data and social media data.

20. The method of claim 17, wherein the auxiliary information is held by a tokenization entity.

21. The method of claim 20, wherein the tokenization entity is distributed cryptographically across several distributed computing devices.

22. The method of claim 21, wherein the tokenization entity is distributed cryptographically across several distributed computing devices via use of secure multi-party computation.

23. A system for privatizing private data, the system comprising:
one or more processors; and
a computer-readable storage device storing instructions which, when executed by the one or more processors, cause the one or more processors to perform operations comprising:
receiving, at a privacy-preserving engine, first sensitive identifiers from a first dataset of a set of primary datasets;
determining, via a fuzzy match algorithm, matches between the first sensitive identifiers and a second sensitive identifiers associated with auxiliary information to yield a fuzzy match determination;
generating, via the fuzzy match algorithm, a set of unique identifiers in which each respective record of the first dataset is augmented by a respective unique identifier from the set of unique identifiers; and
linking records across the first dataset and the auxiliary information based on the respective unique identifier for each respective record.
